(19) United States
(12) Patent Application Publication
(10) Pub. No.: US 2026/0129048 A1
(43) Pub. Date: May 7, 2026

(54) SYSTEM AND METHOD FOR INTEGRATION OF DATA DRIVEN AGENTS WITH LARGE LANGUAGE MODELS

(71) Applicant: Cognizant Technology Solutions U.S. Corporation, College Station, TX (US)

(72) Inventors: Daniel Fink, Berkeley, CA (US); Babak Hodjat, Dublin, CA (US)

(73) Assignee: Cognizant Technology Solutions U.S. Corporation, College Station, TX (US)

(21) Appl. No.: 19/075,141

(22) Filed: Mar. 10, 2025

Related U.S. Application Data
(60) Provisional application No. 63/714,906, filed on Nov. 1, 2024.

(51) Int. Cl. H04L 9/40; G06F 16/2457

(52) U.S. Cl. CPC H04L 63/101; G06F 16/2457

(57) ABSTRACT

A system and method for effective integration of data driven agents with Large Language Models (LLMs) is provided. The present invention provides for seamless integration of agents with LLMs by allowing easy specification and fine-tuning of granularity of agent roles as well as the types of LLMs suitable for each agent's task. The present invention enables specifying the LLMs, therefore allowing to choose LLMs for adequate task performance. The present invention effectively integrates LLM agents and tools from multiple providers. The present invention discloses a system and a method for safe data usage without any data privacy issue.

### CROSS-REFERENCE TO RELATED APPLICATIONS

The present application claims benefit of priority to U.S. Provisional Patent Application No. 63/714,906 entitled SYSTEM AND METHOD FOR INTEGRATION OF DATA DRIVEN AGENTS WITH LARGE LANGUAGE MODELS filed Nov. 1, 2024, which is incorporated herein by reference in its entirety.

### BACKGROUND OF THE EMBODIMENTS

### Field of the Invention

The present invention relates generally to the field of Large Language Models (LLMs). More particularly, the present invention relates to a system and a method for instantiating and networking multi-agent systems, including multiple data driven LLM agents, in order to perform complex tasks.

### Description of Related Art

Different types of Generative Artificial Intelligence (Gen AI) based Large Language Models (e.g., Open AIR, Anthropic®, etc.), are being implemented for ingesting inputs as structured functions (e.g., user prompts, including natural language prompts) to provide a desired output, e.g., new content, such as answers to questions. LLMs can be described as a reasoning engine or cognitive component of a Gen AI system. To facilitate access to the LLM engine by a user, constructs, referred to as agents (also called assistants) have been developed to integrate with an LLM. These agents are code-implemented layers on top of the LLM that observe and interact with LLM based on previous conversations, allowing it to plan and respond iteratively to a user to achieve natural-language goals. The existing art also supports facilitating access by the agent to coded-tools, such as math calculations, web API calls to access a web service, and other functions that LLMs typically do not do well, in order to manage and generate the responses to the user. FIG. 1 exemplifies an existing agent-based single LLM-access system which is supported by the LangChain open-source applications development framework and toolset (library). The agent in FIG. 1 has its own prompts and instructions, but it runs into various limitations. For example, it is limited to access to a single LLM and certain defined tools, and thus will be limited in what it can do, i.e., knowledge-wise and/or time-wise. Different LLMs have varying strengths and weaknesses, costs, and limitations on input/output capacity, affecting their task performance. It would stand to reason that access to multiple LLMs would improve complex task completion.

Accessing multiple LLMs—or having the ability to access multiple LLMs—to complete a complex task is not so easy to implement. Ideally, a user would simply be able to submit their query/task in natural language through a single interface and have automatic access to the knowledge of multiple LLMs. One way to implement such access is to use multiple agents, each agent having a different LLM as its core engine. But, in order to implement multi-agent, multi-LLM scenarios, there are many considerations, including, but not limited to, determining level and granularity of agent roles, types of LLMs (e.g., proprietary), agent integrations with tools, data privacy, limits on interoperability between agents supported by different providers, etc. Further, implementation requires coding experience.

Current offerings involve creating single- or multi-agent systems through specifying the aspects of the agents and stitching these together via code in a language like Python. Deployment of such systems are often subject to lengthy security scans of the software to ensure practices are up-to-date, i.e., as un-hackable as possible, before they can be used by internal corporate entities or outside clients. These are all the tasks of a programmer, yet agent network creation can be at its most creative in the hands of subject-matter experts, who are not necessarily programmers.

Exemplary descriptions of multi-agent systems include: Wu, et. al., AutoGen: Enabling Next-Gen LLM Applications via Multi-Agent Conversation, arXiv: 2308.08155v2 [cs.AI] 3 Oct. 2023; LangGraph's agent architectures including multi-agent systems and Streamlit's single API to multiple LLM product offering. None of these descriptions enable a single-point of access to multiple LLMs to solve a complex problem in a networked fashion. That is, AutoGen and LanGraph refer to a singular LLM agent in the examples provided. While they do describe other non-LLM agents, e.g., search engine, web scraper, as being part of their multi-agent systems, there is no description of a network of agents that provides access to multiple LLM agents. And while Streamlit facilitates access to multiple LLMs, each LLM must be pre-selected by a user before accepting a query/input.

There is a need for a system and a method which provides a multi-agent framework for single-point, provider-agnostic, data-secure user access to multiple LLMs. There is a need for a no-code/low-code system that allows for deployment of multi-agent systems without sacrificing the base-level security of code deployment. And there is a need for a system and method which may be implemented by more creators; not just programmers.

### SUMMARY OF THE EMBODIMENTS

In a first non-limiting, exemplary embodiment, system for facilitating single point of user access to multiple large language models to generate a response to a user query from a access includes: a first network of agents, wherein at least two agents facilitate access to at least two different large language models; and an interface for receiving a user's query and initiating a session with the first network of agents, wherein initiating the session includes creating an instance of a front man agent having access to a first large language model and further wherein the front man agent has access to at least a first branch agent, the first branch agent having access to a second large language model.

In a second non-limiting, exemplary embodiment, a process for generating a response to a user query from a single point of user access to a data-driven network of agents includes: receiving, at the single point of user access to the data-driven network, the user query; initiating an agent session between the user and the data-driven network based on user input in the user query; creating an instance of a front man agent having access to a first large language model; processing, by the first large language model, the user input and determining that additional processing is required to answer the user query; accessing, by the front man agent, instantiation instructions in an agent tool registry at the front man agent, for a first branch agent having access to a second large language model; creating an instance of the first branch agent having access to the second large language model; performing, by the second large language model, the additional processing in accordance with first chat input from the front man agent; returning, by the first branch agent, a first output chat response to the front man agent based on the additional processing; and determining, by the front man agent, that a response to the user query is complete and communicating the completed response to the user via the single point of user access to the data-driven network of agents.

In a third non-limiting, exemplary embodiment, system for facilitating single point of user access to a data-driven agent network to generate a response to a user query includes: a user interface for receiving a user's query and initiating a session with the data-driven agent network, wherein the initiated session includes, an agent tool registry listing each individual data-driven agent in the data-driven agent network and an individual agent specification for each individual data-driven agent, and a designation of a front man agent including a first large language model, for performing initial processing of the user query to determine a response thereto; and multiple tools, wherein at least one of the multiple tools is a branch agent including a second large language model for performing additional processing of the user query to determine a response thereto, and further wherein the front man agent is in either direct or indirect in communication with each of the multiple tools via a data-driven chat streaming session.

In a fourth non-limiting, exemplary embodiment, a system for facilitating single point of user access to a data-driven agent network to generate a response to a user query includes: a user interface for receiving a user's query and initiating a session with the data-driven agent network; an agent tool registry listing each individual data-driven agent in the data-driven agent network and an individual agent specification for each individual data-driven agent, wherein each individual agent specification includes a dictionary of multiple large language models accessible by each individual data-driven agent for generating a response to the user query; and a single user-facing agent from the listing designated as the single point of user access to the data-driven agent network, including access to one or more of the multiple large language models.

### BRIEF DESCRIPTION OF THE FIGURES

Example embodiments will become more fully understood from the detailed description given herein below and the accompanying drawings, wherein like elements are represented by like reference characters, which are given by way of illustration only and thus do not limit the exemplary embodiments herein.

FIG. 1 is a schematic of an existing code-driven LLM agent configuration;

FIGS. 2A and 2B are schematics of a data-driven agent network configuration in accordance with embodiments herein;

FIG. 3 is a schematic of the data-driven agent network of FIG. 2A indicating agent RunContext flow accordance with an embodiment herein;

FIG. 4 is an exemplary message flow using the data-driven agent network of FIG. 2A;

FIG. 5 is an exemplary process flow for data-driven agent network instantiation in accordance with embodiments herein; and

FIG. 6 shows a single hosting scenario for hosting multiple AgentToolRegistries for multiple individual data-driven agent networks in accordance with an embodiment of the present invention.

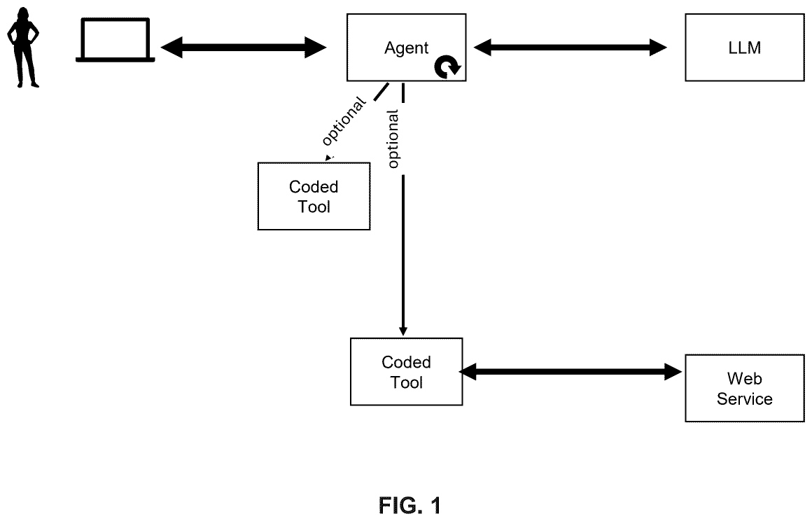

### DETAILED DESCRIPTION

### Definitions

Agent (also referenced herein as “node”): a software program that can interact with its environment, collect data, and use the data to perform tasks.

LLM agent: an agent which uses an LLM as its core engine for problem solving; generating text through complex natural language understanding.

Non-LLM agent: an agent which does not use an LLM as its core engine for performing tasks. By way of example, non-LLM agents may access a web service for information gathering; access a web service to effect change; provide a math function, e.g., be an interface for the agent to use data to make predictions or prescriptions and/or counting; provide and interface with other agent systems and generally perform other tasks which may use rule-based logic, decision trees, or machine learning models for decision-making and response generation. In the present description and figures, non-LLM agents are also referred to as coded tools.

Tool: As defined in the data description of an agent, the names of other LLM and non-LLM agents (also referred to herein as CodedTools) which may be invoked by the agent, but are not required to be invoked for any given task.

Branching agent: an LLM agent with the ability to be called by and to call other agents in the data-driven agent network.

Root agent (or front man): a subset of branching agent identified as the LLM agent point of entry to the data-driven agent network.

Leaf agent: LLM or non-LLM agents in the data-driven agent network which are capable of being called by another agent in the data-driven agent network, but do not make calls to other agents.

The embodiments herein describe data-driven agents and networking of data-driven agents to facilitate single point of user access, as needed, to multiple LLMs and other coded tools, including LLMs that are proprietary and hosted by different providers, to complete complex tasks. In comparison with the existing multi-agent systems, the systems and methods of the present embodiments employ data-driven agents, which are configurable by means of an only-data specification like JSON, HOCON, YAML, etc. A single data-driven agent may be defined by the data characteristics listed in Table 1 (referred to herein as “agent specification”). As will be understood by one skilled in the art, depending on the type of agent, e.g., LLM agent or non-LLM agent, and whether the agent has access to additional tools, some data descriptions would be empty.

TABLE 1

| | |
|---|---|
| agent_name | text handle for other agent specs and hosting |
| | system to refer to |
| function | function spec (standard) that formally describes |
| | the various functional inputs that the agent expects. |
| | An exemplary function spec may be, e.g., OpenAI's |
| | function spec. |
| instructions | text that sets up the agent in detail for its task |
| | and capture the essence of the agent's purpose |
| | and scope in plain language. These generic instructions |
| | can also provide guidance as to when to use (or not use) |
| | the tools (see below). |
| command | optional text that sets the agent in motion after it |
| | receives all its input; could be part of “instructions” |
| tools | optional list of references to other agents that this |
| | agent is allowed to call in the course of working |
| | through their input and instructions |
| llm_config | optional agent-specification (config) for different |
| | LLMs for different purposes such as specialization, |
| | costs, etc. (in priority order), which would include |
| | (but not be limited to): (a) Model name and/or provider |
| | (so that various providers and models can be mixed |
| | and matched for their strengths); (b) Specific (numeric) |
| | limitations on input or output (c) Specifics of endpoint |
| | URLs for access to protected or private LLM models; |
| | (d) Specific references to secrets that allow access to |
| | protected or private LLM models; (e) LLM-specific |
| | parameters for specific model implementations |
| class | The optional language-specific identifier of class name |
| | of the code to invoke for the instance of a non-LLM |
| | agent (e.g., CodedTool). A CodedTool has to implement |
| | a specific interface in order for the rest of the system |
| | to engage with it properly. The CodedTool implementations |
| | have certain technical operating restrictions to work |
| | under. It is important to note that while there is a |
| | coded aspect to these non-LLM agents, how they are used |
| | by other agents in the network is still highly |
| | configurable, completely data-driven, and ultimately |
| | controlled by natural language processes employed by the |
| | calling LLM-based agents. |
| allow | A security-oriented block which has a number of sub-fields: |
| | “sly_data” - allows for specific private data key/ |
| | value pairs to be forwarded to an external agent or back |
| | to the client. The idea is that secret information like |
| | access tokens should be allowed to be passed on with |
| | specific intent. |
| | “connectivity” - allows for internal agent network |
| | connectivity information to be sent back to the client. |
| | This is normally an implementation detail for consumers |
| | of agents and some agent networks might not want to spill |
| | any beans about secret sauce. |
| | “messages” - allows for internal agent conversational |
| | chatter to be sent back to the client. This is useful for |
| | visualizing/explaining what is going on under the hood and/ |
| | or debugging/fine-tuning instruction prompts for agents. |
| args | Allows for specific key/value pair arguments to be passed |
| | to CodedTools so as to provide greater re-use/abstraction |
| | of CodedTool implementations. |
| commondefs | a way to provide a single definition of a string or value |
| | that is used repeatedly throughout the agent network. |
| | This reduces copy/paste errors. |

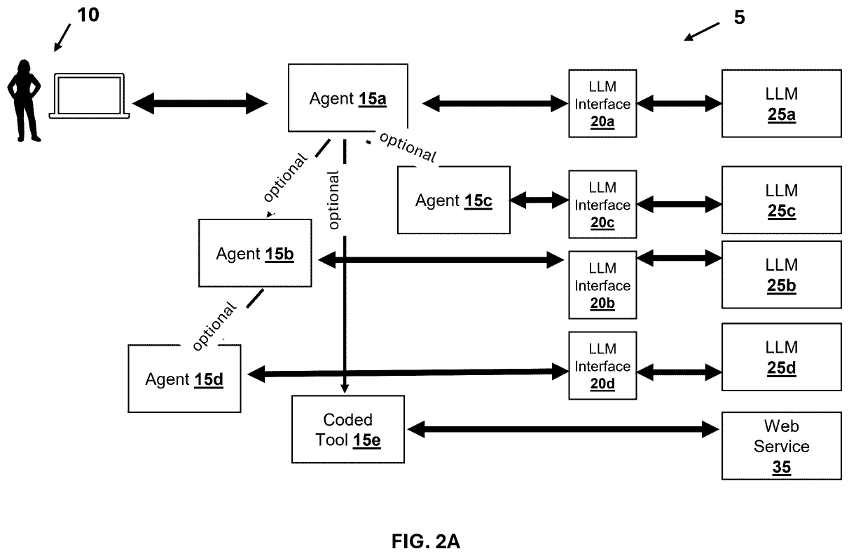

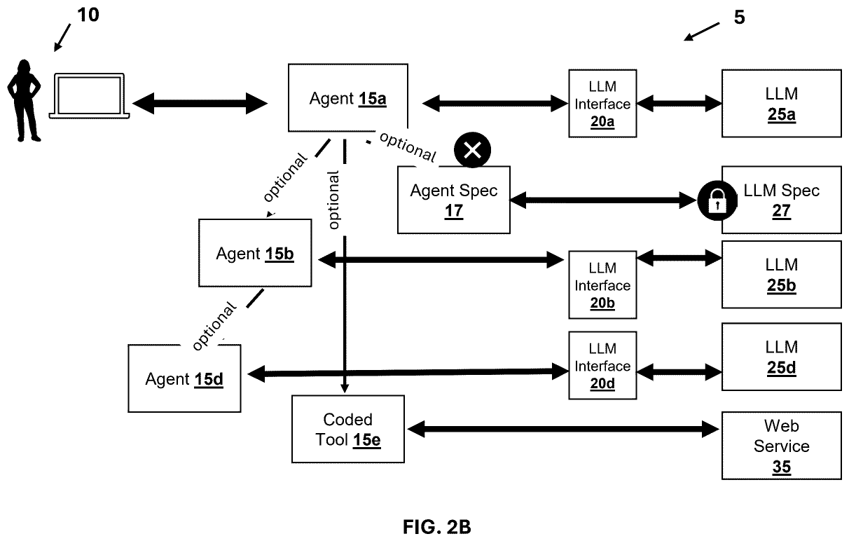

FIG. 2A is a schematic showing an exemplary network 5 of multiple data-driven agents (also referred to herein as nodes) 15a, 15b, 15c, 15d and 15e. Each agent 15a to 15d is an LLM agent and interfaces with a different LLM 25a, 25b, 25c and 25d via LLM interfaces 20a, 20b, 20c and 20d, respectively. Additionally, agent 15a has access to coded tool 15e, a non-LLM agent, for making web calls to web service 35.

FIG. 2B is a schematic showing an exemplary network 5 of multiple data-driven agents (also referred to herein as nodes) 15a, 15b, 17, 15d and 15e. Each agent 15a, 15b, 17 to 15d is an LLM agent and interfaces with a different LLM 25a, 25b, 27 and 25d via LLM interfaces 20a, 20b, and 20d, respectively or directly in the case of LLM Spec 27. The agent 17 with direct link to LLM specification 27 is intended to represent the concept of a private LLM, as compared to public LLMs like ChatGPT. Privately hosted LLMs may be designed to work on specific types of data, including private data (e.g., healthcare data, financial data, etc.), employment of fine-tuned models using specialist data, control of where the chat stream can go for secure LLM operations, cost controls, control over latency of LLM answers, among many other potential uses.

As shown in FIGS. 2A and 2B, a user 10 query has access to all of the identified resources via single access point, agent 15a. The exemplary network 5 shown in FIGS. 2A and 2B is but one example of a multiple data-driven agent network which may be implemented in a tree or graph architecture in order to readily break a complex problem introduced to the network by the user 10 into smaller parts for handling by other agents in the network in accordance with agent specialization. The network facilitates access to the full range of networked resources, including multiple agents, both LLM and non-LLM based. Generally, the data-only characteristics of a network of agents includes: a listing of all the available agents in the network, as described above, with other linked tools listed in each of the individual agents' data description; a designated or discoverable LLM agent; and optional section with common definitions (“commondefs”) all agents can access, e.g., default configs of one or more specific LLM models (in priority order) to use when none is specified on a per-agent basis, shared definitions of the data that describes functional inputs, shared snippets of generic instructions to ensure precision in a larger network of agents.

The core library for the agent network framework described herein includes the features of Table 2.

| Core | |
|---|---|
| Library Feature | Function |
| AgentSessions | for communicating with instances of our |
| | mutli-agent system as an abstraction. |
| | Implementation include |
| | synchronous/asynchronous versions of |
| | Http/Grpc/Direct. |
| MessageProcessor | handler implementations for finding needles in |
| | message-streaming haystacks |
| InvocationContext | Locus for answering policy/data questions |
| | whose scope is a single call to an |
| | AgentSession |
| RegistryManifest | allows for reading multiple hocon files each |
| | describing its own agent network to be served |
| | by a single server |
| AgentToolRegistry | for parsing and policy of agent hocon specs |
| | pertaining to a specific agent network |
| ConfigFilters | for consistency in applying commondefs and |
| | defaults among agent specs |
| AgentNodes | like BranchingTool, FrontMan, ClassTool (for |
| | calling CodedTools), ExternalTool (for calling |
| | other agent networks to make an agent web) |
| CodedTool | Tool node with hard-coded functionality (non- |
| | LLM) |
| Error detectors | for consistent interception and reporting of |
| and formatters | problems in the chat streams |
| SlyDataRedactor | for paring down sly_data per spec when |
| | sending to an external agent network |
| Messages | specific messages with different kinds of |
| | content to stream to the client (e.g., |
| | AgentFramework, AgentToolResult, Agent |
| | (thought) messages) |
| Origination | policy to keep track of where in the hierarchy |
| | a message comes from. Example: sometimes a |
| | single agent is used multiple times and we |
| | have to give an instance number to keep track |
| Journals | for passing messages from the agent internals |
| | to stream to the client |
| RunContext | for corralling input/output to a specific agent |
| | system with Run/ToolCall instances, logging, |
| | argument passing, etc. |
| LllmFactory | from llm data-only specification, instructs the |
| | system to use a specific LLM model for use |
| | by the calling RunContext |

At the heart of the agent network framework is an AgentToolRegistry, whose input is a listing of dictionaries of the data-only agent descriptions, e.g., agent specifications, for registered agents in dictionary (key/value mapping) form. The dictionary list form allows for cycles in the connectivity between agents, e.g., Agent A calls Agent B, which calls Agent A. Dictionaries can be hard-coded, or read from a JSON (JavaScript Object Notation), Hocon (Human-Optimized Configuration Object Notation), YAML (yet another markup language), XML (Extensible Markup Language), etc. file by one or more readily-available libraries previously developed for that purpose. The AgentToolRegistry is able to answer queries from clients about the specific registered agent for use in the agent network, e.g., which one might be considered the chat “front-man” and/or which one is designated as the entry-point function. One of the most important functions of the AgentToolRegistry is to create the appropriate agent graph node instances for root, branch, and leaf nodes of the agent network when they are activated/employed by their calling agents” at the end for clarification. The individual data-driven agents in a network can be categorized within the data-driven agent network framework by their specific communication abilities, i.e., their ability to call (root, branch) and/or be called (root, branch, leaf) by the user and/or other agents. Additionally, the present embodiments include identification and access instructions to an “External Tool” wherein one agent network calls another via communication between agents of two different networks; potentially on separate servers across the globe.

An exemplary specification of a simple data-drive LLM agent network is presented below for reference only.

```
{
  “llm_config”: {
    “model_name”: “gpt-4o”,
  },
  “tools”: [
    # These tool definitions do not have to be in any particular order
    # How they are linked and call each other is defined within their
    # own specs. This could be a graph, potentially even with cycles.
    # This first guy is the “Front Man”. He is identified as such because
    # he is the only one with no parameters in his function definition,
    # and therefore he needs to talk to the outside world to get things rolling.
    {
      “name”: “announcer”,
      # Note that there are no parameters defined for this guy's “function” key.
      # This is the primary way to identify this tool as a front-man,
      # distinguishing it from the rest of the tools.
      “function”: {
        # When there are no function parameters to the front-man,
        # its description acts as an initial prompt.
        “description”: “““
I can help you to make a terse anouncement.
Tell me what your target audience is, and what sentiment you would like to relate.
”””
      },
      “instructions”: “““
You are an author of terse announcements.
You will be asked to help writing an extremely terse announcement on behalf of a person or
organization.
You will ascertain the intended sentiment of the desired announcement
as well as who the target audience is for the announcement
and come up with something as short as possible to express the sentiment to the audience,
while never divulging the identity or nature of who has requested the announcement.
Then, after you have come up with what to say, you will always call a function
to make the announcement as simple and concise as possible, yet eloquent.
The synonymizer will need a name for the speech.
”””,
      “tools”: [“synonymizer”]
    },
    # The synonymizer is the lowest level tool and does not call anyone else.
    # He is called by the front-man.
    {
      “name”: “synonymizer”,
      “function”: {
        “description”: “Returns sequences of synonyms.”,
        “parameters”: {
          “type”: “object”,
          “properties”: {
            “name”: {
              “type”: “string”,
              “description”: “A brief description of the input”
            },
            “input_string”: {
              “type”: “string”,
              “description”: “Words, phrases, or sentences to use as input”
            }
          },
          “required”: [“input_string”, “name”]
        }
      },
      “instructions”: “““
You are a thesaurus.
You will be handed an arbitrary number of words in a particular order
and for each word in the sequence, you will find a synonym for it
that is only 5 letters long.
If no synonym exists for a word in the sequence, only then may you simply use the original
word.
Your output will be words or phrases that match the original form and order of the input,
except the synonyms will replace the original input words.
There will be no elaboration or additional commentary.
”””,
      “command”: “Find a synonym string given the input_string”
    }
  ]
}
```

Central to operation of a data-driven agent network of the present embodiments are branching agents which are defined as such by their bi-directionality, i.e., their ability to call or be called by other agents in the network. Branching agents are always LLM agents. Specifically, branching agents take as input at instantiation: a RunContext which contains references to shared state like common resources (e.g., service connections) to be shared with its input (upstream) and output (downstream) nodes in the agent network; a Journal, i.e., reporting conduit for multiple agents, which retains LLM chat history of an agent's own internal conversations with itself and other nodes in the network it might call (individual agent chat history is retained as state on each RunContext); an instance of the AgentToolRegistry, so it can initiate agent-based chat with its downstream agent network tools; a dictionary description of the values of its functional arguments provided by its upstream caller, per its own function spec; and a reference to its own single-agent tool data spec. The reference to its single-agent tool data spec tells the branching node agent what LLM to instantiate as a basis for its agent, and what specific parameters are required to do that (API Keys, etc.), what instructions to give that LLM's Agent instance, as a basis for chat, and the list of other downstream agents that are available to it to call. Communications between agents are intent-based and often in natural language, making the interactions more understandable and reducing the complexity of integration.

When initializing the underlying LLM models and agents, these branching agents, combine their generic instructions provided in their function spec with information received about the specific input parameters provided by their caller, i.e., immediate parent agent, and then set the underlying LLM agent in motion by submitting its first set of “specific instructions”. The specific agent infrastructure calls the specific agent's underlying LLM and autonomously waits for a response given its own decision-making algorithms. Exemplary agent infrastructure for making such LLM calls as provided by LangChain or OpenAI may be used, but is not limited thereto. Depending on the received response, the branching agent has its own control loop which abstractly consults the RunContext implementation's agent infrastructure to see if its agent's run requires further action. If further action is required, it makes more tool calls until the criteria for further action is satisfied. The further action could be additional calls to the node's own LLM as per the specific agent infrastructure provided by, e.g., LangChain or OpenAI. Or the action could be calls to a downstream agent's LLM or CodedTool. For calls to a downstream agent's LLM, the calling agent's llm_config data includes data for making the call. Table 3 provides an exemplary no-code LLM specification for other agent LLMs.

TABLE 3

| | |
|---|---|
| model_name | name of the model to use (i.e. “gpt-4o”, |
| | “claude-3-haiku”) |
| *_api_key | api key value or environment variable to |
| | reference to allow access to the LLM |
| | provider if different from hosting |
| | environment default. |
| temperature | optional level of randomness 0.0-1.0 to |
| | use for LLM results |

When the branching agent is satisfied that it does not need to take any further action downstream in the agent network, it forwards a response to its caller in the agent network. The response can be a definitive answer, or a specific agreed-upon message as a request for more information from further upstream in the agent network. Referring back to the exemplary data-driven LLM agent network 5 of FIGS. 2A and 2B, LLM agents 15a and 15b are branching agents. And agent 15a is a special case of a branching agent, root agent (also referred to herein as “front man”) described below.

The root agent branching node has a special responsibility in the data-driven LLM agent network of the preferred embodiment in that, while it is itself a branching agent and is able to call its own set of other agents (specified in the tools listing in its agent specification), as part of the network, it needs to be sure to gather the initial requirements of the query from the user, and to be able to further initiate clarifying chat with the user (or the caller in a web-hosted function) when downstream agents need more information. As such, the root agent has its own submit message( ) method as an entry point into the agent network. This submit message( ) initiated method either perpetuates the network agents' conversation amongst themselves or possibly returns with an upstream response either for clarifying information or a final response from the agent network to the user/caller. Root agent downstream calls are enabled as described above for branching agents. The root agent may be identified as an entry point to the agent network due to its lack of a rigorous functional input description which signals the node to a chat system as a “front-man” that interacts with a user in a chat system which calls specified agent networks on behalf of the user. Alternatively, the root agent could optionally include, like its down-chain agents, a rigorous functional description as a means to be called by another agent network as an entry point to engaging with its functionality. Such a root agent requires a specific designation, such as being first in the list, so it can be properly pegged by the system for its special status as a bridge to the external caller (which might reside on an entirely different server).

The data-driven agent network may also include leaf agents, which are defined by their ability to be accessed (called) by a branching agent, and use an LLM for operations, but leaf agents do not have the capability to make calls like branching agents. Leaf agents take as input: a RunContext which contains references to common resources (i.e. service connections) to be shared with its input (upstream) node; a Journal which retains LLM (chat) history of its own internal conversations with itself; a dictionary description of the values of its functional arguments provided by its upstream caller, per its own input function spec; and a reference to its own single-agent tool data spec. The reference to its single-agent tool data spec tells the leaf agent what LLM to instantiate as a basis for its agent, i.e., itself as an LLM agent, and what specific parameters are required to do that (API Keys, etc.), what instructions to give that LLM's Agent, i.e., itself, as a basis for chat. Referring back to the exemplary data-driven LLM agent network 5 of FIGS. 2A and 2B, leaf agent 15d is a leaf agent.

The non-LLM agents of the data-driven agent network, also called coded tools (CodedTools), can be referenced by language-specific class identifiers that can perform hard-coded functions that natural-language-based LLMs are not necessarily good at, such as specific math functions, or gathering the minutia from the tool inputs to make a call to a specific website for site-specific information. Referring back to the exemplary data-driven agent network 5 of FIG. 2, agent 15e is a CodedTool. While these tools are hard-coded and do not require an LLM to function (though theoretically they could), they still need a node in the agent network that calls them as functions and returns their output to upstream agents in a manner consistent with the rest of the infrastructure described above. The value in including CodedTools as part of the system is the ability to improve the performance and scope of function of the data-driven agent network as a whole by making these available for combination with other agents. Table 4 provides an exemplary data specification for lo-code tools used in the preferred embodiment. Note that the data specification in Table 4 is a specific case of Table 1.

TABLE 4

| | |
|---|---|
| agent_name | text handle for other agent specs to refer to |
| function | function spec (standard, e.g., Open AI) that |
| | formally describes the various inputs that |
| | the tool expects |
| class | code reference to the class that implements a |
| | specific CodedTool interface provided with |
| | the SDK. |
| args | Specification for CodedTool allows for greater |
| | re-use of CodedTool logic within a network by |
| | being able to specify some aspects of how the |
| | CodedTool instance is called that is out-of-reach |
| | from LLM control. Example: given a CodedTool that |
| | will retry access to a website a certain number |
| | of times, the Agent/LLM might pass along the URL |
| | to the website as an argument, but you don't |
| | want the Agent/LLM deciding how many times to |
| | retry the website if there are problems because |
| | it just does not have that level of experience. |
| | Accordingly, specifying: |
| | “args”: { |
| | “retries”: 3 |
| | } |
| | would make the CodedTool flexible to handle any |
| | number of retries, but take the decision of how |
| | many retries to do out of the hands of an |
| | inexperienced LLM and into the hands of the agent |
| | network designer and/or devops manager. |

CodedTool implementations must: inherit from our CodedTool interface specification; have no arguments for their constructor; implement an invoke( ) synchronously or an async_invoke( ) method asynchronously (preferred) which takes 2 parameters as arguments. The first parameter is “args” which is an argument dictionary whose keys are the parameters to the coded tool and whose values are the values passed for them by the calling agent (this dictionary is to be treated as read-only. The spec for the requirements of this dictionary is specified like any other agent with its “function.parameters” (see hello_world example above for reference even though it doesn't use coded tools). The second parameter is * sly_data which is a dictionary whose keys are defined by the agent hierarchy, but whose values are meant to be kept out of the chat stream to ensure data privacy. This dictionary is largely to be treated as read-only. It is possible to add key/value pairs to this dictionary that do not yet exist as a bulletin board, as long as the responsibility for which coded_tool publishes new entries is well understood by the agent chain implementation and the coded_tool implementation adding the data is not invoke( )-ed more than once.

As described above, each LLM agent in the data-driven agent network, which includes branching agents and leaf agents, has its own RunContext to manage the lifetime of the nodes' resources, shared resources, e.g., web service connections to LLM providers, and agent state. The agent's RunContext contains node-specific library agent instance and chat history. When a new LLM agent is activated, the new agent's resources can be shared by the upstream agent with the downstream agent. By way of example only, Table 5 provides exemplary naming conventions and definitions used to represent functions and methods related to node resources and implementation-specific policy related to node resources:

TABLE 5

| | |
|---|---|
| create_resources( ) | takes as arguments elements of the single- |
| | agent specification and is the place for |
| | resources to be created that will last the |
| | lifetime of a single agent |
| delete_resources( ) | takes no arguments, but frees up whatever was |
| | allocated in create_resources( ) when the |
| | agent's lifetime has ended |
| submit_message( ) | takes as input a single text message and |
| | initiates interaction with the underlying LLM- |
| | based agent system. This returns a handle so |
| | the running of the message can be tracked. |
| wait_on_run( ) | takes as arguments a run handle given by |
| | submit_message( ) above and a chat stream |
| | Logger which will capture the conversation |
| | happening with the LLM. This basically waits |
| | until there is some kind of message returned |
| | from the agent implementation. |
| get_response( ) | used to get the LLM chat response(s) after a |
| | wait_on_run( ) |
| submit_tool_outputs( ) | takes as input chat output from called tools to |
| | be integrated with the agent's “thinking” and |
| | response stream. |

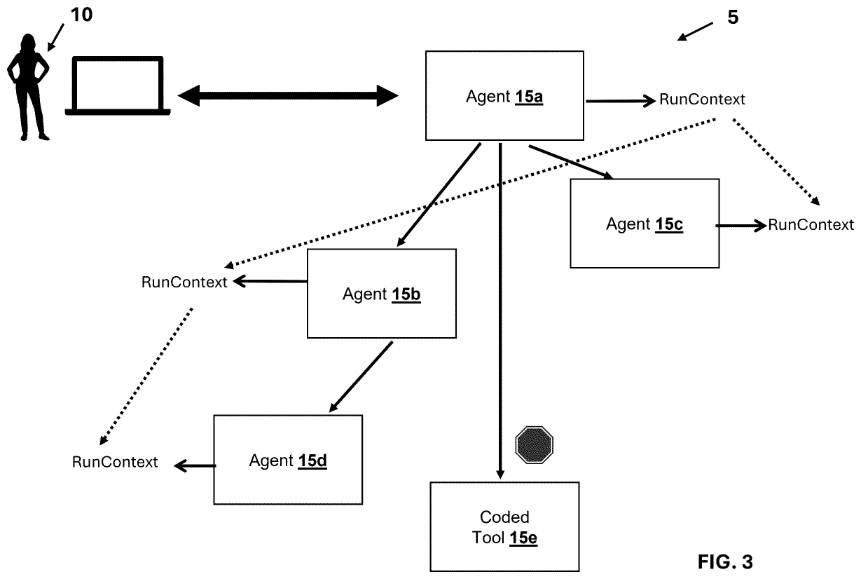

All of these methods are called at various points in a branching agent's operation within the data-driven agent network as described herein. Leaf agents do not call tools and thus will not call submit_tool_outputs( ) on a RunContext. One skilled in the art will appreciate that different RunContext implementations are possible for different implementations of agent systems. For example, RunContext implementations vary for an agent's specific individual LLM library (i.e., LangChain vs. OpenAI) separate from common agent RunContext implementations for the data-driven agent network framework. FIG. 3 shows how the RunContexts for the LLM agents in the exemplary data-driven agent network 5 of FIGS. 2A and 2B are shared. Note that non-LLM agent 15e may have no need for RunContext.

LlmFactory takes the 11m data-only specification and instructs the system to use a specific LLM model for use by the calling RunContext in its create resources( ) call when it creates the appropriate agent. The breadth of LLMs accepted is often limited by the implementation choice for RunContexts because some implementation details of those might be LLM-vendor-specific. That said, because each agent in the network can use a different LLM instance, lighter-weight and lower-cost models can be configured for simpler tasks, while beefier models can be configured for heavier lifting. Because the LlmFactory can be passed configuration information that routes interactions to privately-hosted LLMs, the nature of the agent-generated traffic to those instances has a chance of being kept private.

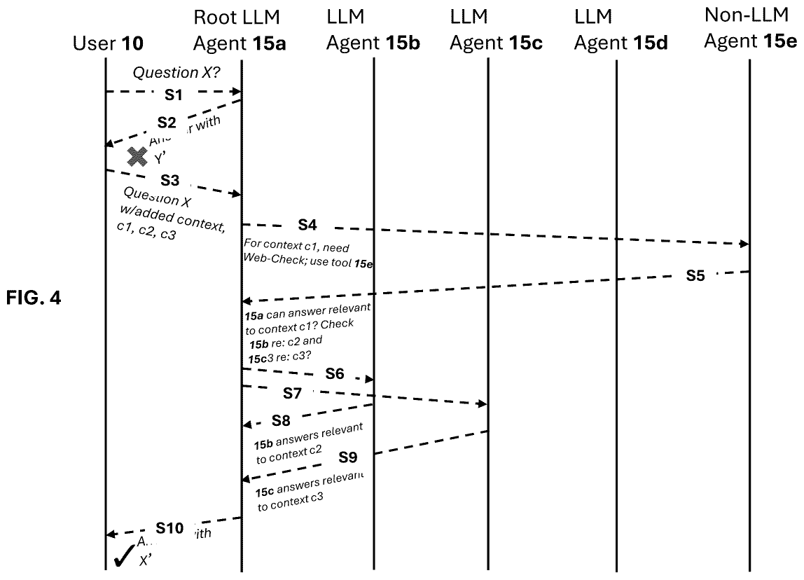

FIG. 4 is an exemplary high level agent-to-agent message flow using the data-driven agent network of FIG. 2A. In step S1, the user 10 submits a query (or prompt) to the network. The query is received by root agent 15a which attempts to answer the query. Depending on agent 15a's processing, additional information from the user could be requested, a determination that a different agent in the network should be accessed or an answer to the query could be returned. By way of example only, in FIG. 4, agent 15a returns an answer S2. The user determines that the answer is not responsive or is lacking in some way and modifies the query to add additional features or context text and re-submits the query to root agent 15a at S3. In the example flow of FIG. 4, the root agent 15a determines, given the revised query that it is able to provide a partial response, but needs to consult a non-LLM agent 15e for a web-check S4, which returns response S5. Root agent 15a also determines that additional relevant information to answer the revised query may be available from agents 15b and 15c and consults these agents in messages S6 and S7. Agents 15b and 15c provide responses S8 and S9, respectively. Finally, root agent 15a consolidates all responses and provides a correct answer to the user in message S10.

As will be appreciated by those skilled in the art, a data-driven agent network as described above may be hosted using different infrastructure configurations to enable client-access to the networks. By way of example, the described agent network can be an engine that drives a chat session within a chat-based system whose arbitrary yet complex function is described with a single data file. This enables a completely configurable natural language chat system (UI or command line). Agent networks enhance the functionality and specificity of the tasks that chat agents powered by only a single LLM-instance cannot perform. One skilled in the art will appreciate the modifications and consolidations which may be considered in the APIs implementing agent sessions. Tables 6 and 7 are exemplary. Referring to Table 6, a chat session is initialized, constructor( ) with an instance of an AgentToolRegistry and the set-up steps of creating the Root Agent/Front Man and its resources, function( ) is performed. The generic instructions for the Front Man generates a prompt, chat( ) for the user in their chat session providing the user the scope of the task the data-driven chat bot is configured for. The user engages in natural language conversation with the Front Man providing all the input until the Front Man's submit message( ) logic detects that there is enough information to call the nodes in the agent network. Additional session features could include logging and returning chat history, logs( ) and freeing up agent resources, reset( ).

TABLE 6

| | |
|---|---|
| constructor( ) | takes a single agent registry spec (in dictionary |
| | form) as an argument |
| function( ) | returns the function spec for the front-man/root |
| | agent |
| connectivity( ) | This call returns connectivity information for |
| | the agent network so that a client has an idea |
| | of what inside the network is connected to what. |
| | It's possible that the agent spec will not |
| | allow certain bits of connectivity info to be |
| | communicated - left as a private implementation |
| | detail via the “allow” block's “connectivity” |
| | parameter above. |
| streaming_chat( ) | In updated version (V2) of API, this call |
| | encapsulates all 3 of the (V1) API calls below. |
| | This method takes a user input string to initiate |
| | agent action. While it is running, it streams |
| | back to the caller messages as to various |
| | agent's progress depending on “allow” |
| | configuration. At the end, the final message is |
| | a chat history summary so a subsequent call with |
| | the same context can be made. The each messages |
| | comes with an “origin” describing where |
| | in the agent network it is originating from. This |
| | level of message granularity feeds visualization |
| | aids. This streaming API is also perceived as |
| | having quicker performance because message |
| | feedback comes as it happens. |
| chat( ) | (V1) Allows clients to send natural language text |
| | input to the agents. Upon first call, the initial |
| | LLM connection with the Front-Man/root is |
| | invoked. Private data also sent here. |
| logs( ) | (V1) returns the chat history so far |
| delete_resources( ) | (V1) frees up resources associated with the agent, |
| (or reset( )) | including any and all LLM sessions, sockets, chat |
| | history, etc. |

Implemented as part of a web service that hosts one or more complex data-driven agent network as its own function, the Root Agent is described as a function necessitating specific inputs as part of the request to some web service infrastructure. Requests to such a service would include: obtaining the functional specification of the hosted agent or agent sub-network. Results are a matter of returning existing function JSON. And invocation of the agent/agent sub-network with specific arguments. Invocation requests might be implemented as a map of key/value pairs of argument name to value so they can be generically translated directly into agent function arguments. Note that the map is not strictly required, as greater security/argument validation might be desired for specific functionality. The response of the web-hosted function invocation is the final answer from the agent network or some representation of an “I need more information” response to feed back to the caller. The caller is free to call the web-hosted function with more refined function arguments as often as is needed. Table 7 provides exemplary agent as a web service interface programming naming conventions and definitions.

TABLE 7

| | |
|---|---|
| connect address | by host/agent-registry name. For privacy, host |
| | refuses connections to agent networks that don't |
| | exist - no fishing. |
| function( ) | returns the function spec for the front-man/root |
| | agent. Sending the full function spec over the |
| | wire rather than just the description/prompt |
| | enables agent webs. |
| connectivity( ) | This call returns connectivity information for the |
| | agent network so that a client has an idea of what |
| | inside the network is connected to what. It's |
| | possible that the agent spec will not allow certain |
| | bits of connectivity info to be communicated - left |
| | as a private implementation detail via the “allow” |
| | block's “connectivity” parameter above. |
| streaming_chat( ) | In updated version (V2) of API, this call |
| | encapsulates all 3 of the V1 API calls below. |
| | This method takes a user input string to initiate |
| | agent action. |
| | While it is running, it streams back to the caller |
| | messages as to various agent's progress depending |
| | on “allow” configuration. At the end, the final |
| | message is a chat history summary so a subsequent |
| | call with the same context can be made. Each |
| | messages comes with an “origin” describing |
| | where in the agent network it is originating from. |
| | This level of message granularity feeds visualization |
| | aids. |
| chat( ) | (V1) Allows clients to send natural language text |
| | input to the agents. Returns a session id to continue |
| | the conversation and inspect results. Private data |
| | also sent here. |
| logs( ) | (V1) given a session_id from chat( ), returns the |
| | chat history so far |
| delete_resources( ) | (V1) starts the session from scratch by freeing |
| (or reset( )) | resources associated with the agent, including any |
| | and all LLM sessions, sockets, chat history, etc. |

An application executing on a smartphone, or other computer, can use the data-driven agent network as a function call. This case is the same thing as the Web-Hosted Function above, except all the web services infrastructure is substituted for a direct call to the Root Agent's submit message( ) method.

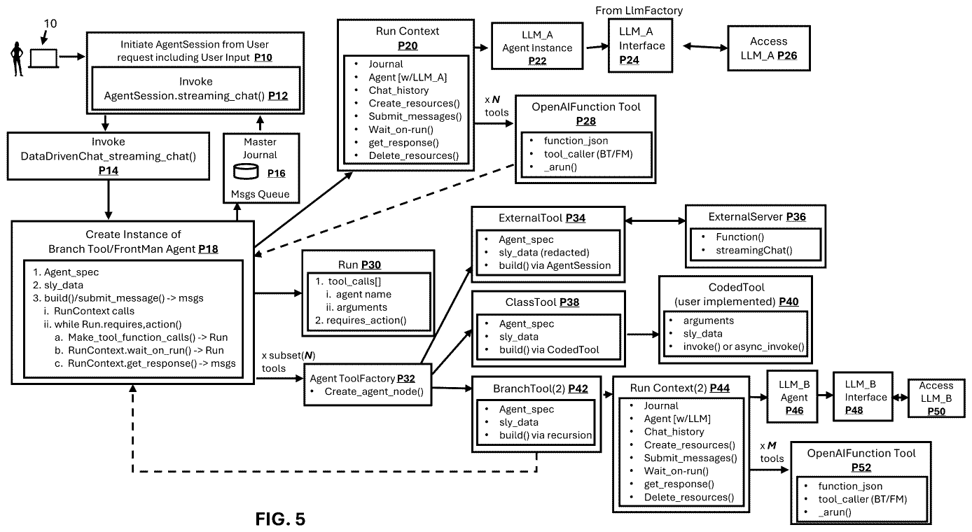

FIG. 5 illustrates an exemplary process and information flow within an exemplary data-driven agent network configured as described herein. Initially, in FIG. 5, a request bearing user-input comes into an AgentSession (either by method or web service call) P10. AgentSession.streaming_chat( ) is invoked P12. An asynchronous invocation of DataDrivenChat.streaming_chat( ) is set up to happen in a separate thread P14 while the AgentSession itself, prepares to receive a stream of messages from a queue P16 for repackaging and forwarding on to client application or code. When tool calls are employed to “make real” a node in the agent graph from the AgentToolRegistry specs; an instance of a Journal, which has access to a queue P16 that feeds messages back to the caller 10 (see below); an instance of the front-man's agent spec dictionary (Agent_spec); any sly_data (private data) that was passed in as part of the request. DataDrivenChat.streaming_chat( ) P14 is passed the user input, the sly_data dictionary (both passed as part of the request) and an InvocationContext object which will be passed around to the system below. This InvocationContext contains policy objects for the lower-level calls to reference when there are different behavioral decisions to be made. As the messages come over the queue, they are streamed back to the caller from AgentSession.streaming_chat( ) P12. The messages themselves get thrown on the queue P16 at various points within the asynchronous call to DataDrivenChat.streaming_chat( ) P14 from a separate thread.

An instance of the first branch tool/front man (BT/FM) is initialized P18. In accordance with Agent_spec and sly_data, the BT/FM implements build( )/submit_message( ) functions including runcontext calls and while run.requires.action( ) functions as listed. A RunContext P20 is created for the BT/FM per the Agent_spec (e.g., LangChain vs OpenAI) with some information as to the name of the front man agent. This is stored as part of the origin to be used for sending messages back indicating where in the agent hierarchy any given message is coming from. RunContext P20 includes journal, agent [w/LLM_A] and chat_history and implements function calls including create_resources( ), submit_messages( ), wait_on-run( ), get_response( ) and delete_resources( ). The RunContext's create_resources( ) is invoked which does the following: consults the Agent_spec for which LLM Config to use; asks the LLMFactory to create an instance P22 and interface P24 to access the LLM_A P26 in question. It also creates Tool instances using for any tool listed in the Agent_spec to be available for optional later use (depending on what the LLM/Agent decides to use within its own reasoning). In FIG. 5, for each tool that might be used an OpenAIFunction Tool is exemplified P28 to perform the desired function (Tool) calling so that actualized tool functionality within our system can be subverted as per the agent_spec. At this stage, each Tool instance is an OpenAIFunctionTool, which is bridging code that allows us to route a LangChain agent Tool call to whatever we want later. This acts as a placeholder so the Agent making the decision knows what it *can* call. That is, it answers the question for the agent: “What could I call?”. It's not until later when the decision to call a tool is made by an LLM, that the real instantiation of a node in our own graph is made. That is: “What am I going to do?” Upon realization of a new actualized tool, the AgentToolFactory P32 is consulted as to each agent's function spec in constructing each Tool instance, i.e. Create_agent_node( ). A Langchain ChatPromptTemplate of a few messages is created per LangChain recommendations. These include: a system message which holds the instructions; a placeholder message which holds the (impending) chat history; a “human” message which holds the input to the caller (user or agent generated); and a placeholder message for the “agent scratchpad” to allow a place for agent decisions to be kept. Finally, a LangChain Agent instance itself is created P20 passing it the LLM instance to access LLM_A P22, the tools list and the prompt template. All of the above are kept as state in the RunContext instance. As one skilled in the art will appreciate, this LangChain implementation overcomes possible limitations with closed system implementations such as OpenAI-only implementations which requires the steps to be run on OpenAI servers. In order for an OpenAI-only assistant to invoke a CodedTool, for instance, system admins would have to hand over the keys to their own systems and allow for a black-box agent of questionable reliability to execute blindly.

Now, inside BT/FM agent's submit_message( ) its RunContext.submit_message( ) is called with the user input which returns a framework-agnostic Run handle. A loop is entered waiting for a certain agent-specific criteria to happen. The RunContext.wait_on_run( ) waits for results from the RunContext's LLM P26. If the results from the Run.requires_action( ) indicates there is more to do, (however that is defined by LangChain, or OpenAI or whatever framework is being used), the BT/FM agent's make_tool_function_calls( ) is invoked and the termination criteria for the loop is not met, so we keep looping until there is nothing more to do (additional discussion below). If the results indicate there is nothing more to do, we get the response and return that as the result of submit_message( ) This ends up being the final response from the BT/FM agent which is returned to the user.

When the BT/FM agent's make_tool_function_calls( ) is invoked, the method is passed a Run P30 result which holds a list of tool names that the agent logic wishes to invoke and with what parameters. These are all determined by lower-level framework agent, e.g., LangChain, logic in conjunction with the LLM selected. That is, the LLM itself decides what tools to call. For each tool that the agent wants to be called: get the name of the tool (agent name) to be called, get the arguments to be passed to the tool, instantiate a new node in our graph via the AgentToolFactory P32 that corresponds to the agent_spec of the tool to be called. The AgentToolFactory P32 will create one of the following nodes based on the spec: ExternalTool P34, ClassTool P38, BranchTool P42. An ExternalTool P34 is used to invoke an agent network on another, external server P36. When created, an effort to redact the sly_data is made to only allow passing sly_data items that have been explicitly allowed by the agent's configuration. A ClassTool P38 is an internal representation which knows how to invoke the user's CodedTool implementation P40. A BranchTool(2) P42 is an internal representation that allows invocation, via Run Context(2) P44 of another LLM-based agent instance P46 via interface P48 to access a different LLM_B P50. As with the BT/FM agent's call to LLM_A, BranchTool(2) P42 an OpenAIFunction Tool P52 may be implemented by LLM_B to perform its desired function (Tool) calling.

Each tool above is instantiated with access to the following: its parent node's RunContext instance (so it can make its own based on that if needed); the Journal instance for sending messages, the AgentToolFactory instance so its later possible tool calls can go through the same procedure; a copy of its own agent spec dictionary; the arguments passed by the LLM; and the single sly_data instance for private data shared by all the agents within the network.

A build( ) method is invoked on the newly realized node/tool. This sets the tool in motion (asynchronously), but this means different things for different kinds of nodes/tools. For an ExternalTool the build( ) method invokes the external agent network referenced in the spec by calling its streaming_chat( ) and waiting for the results to come in. For the ClassTool, the build( ) method instantiates and calls the invoke ( ) method of the CodedTool referenced in the spec and results are returned as a plaintext string. It is within a CodedTool's invoke ( ) that calls to web services and use of the sly_data are made if needed. For a BranchTool, build( ) method: calls create_resources( ) on its new RunContext, invokes the Agent/LLM with a call to RunContext.submit_message( ) with the instructions and command from its spec, along with text that specifies what the arguments are; waits on the Run that is produced from that submit_message( ); enters a similar loop as that of the front man which looks to see if the results require more action and if more action is required, a recursion into make_tool_function_calls( ) is made, but this time at the level of a different agent within the hierarchy (not the front man); and reports the results when that loop is finished. We note an important distinction here, wherein the spec describes what could happen, while the LLM Agent decides what actually happens.

Results from each tool/node invoked (there might be more than one at a time) are compiled back into the chat history stored in the RunContext and sent over the queue in the Journal for reporting back to the client. Each tool/node that is actually called has its RunContext's delete_resources( ) method called, thus tearing down any resources associated with that agent's communication with the outside world (LLM or agent network, or whatever).

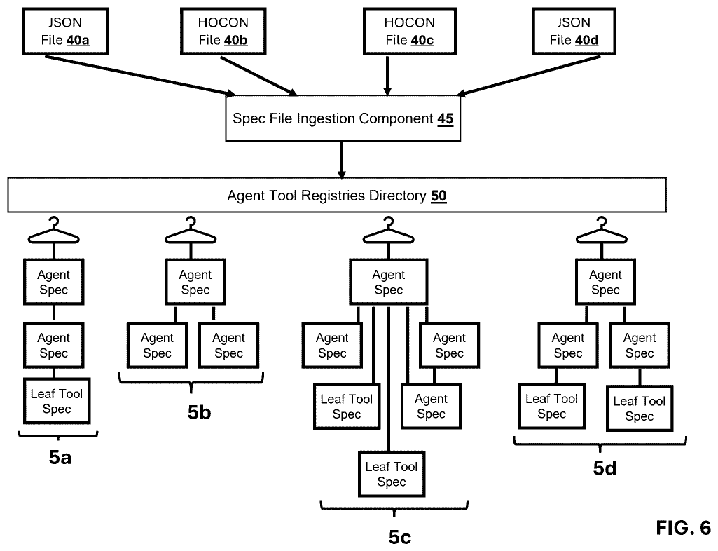

Note that multiple AgentToolRegistries can be offered from a single host. As shown in FIG. 6, each AgentToolRegistry represents an independent agent network 5a, 5b, 5c and 5d described in a separate input text data network specification file 40a, 40b, 40c, 40d, ingested by component 45 and stored within the registry directory 50 under a unique filename. The AgentToolRegistry can be hosted as a library or web service and accessed by multiple clients, e.g., code, chatbots, web services, etc.

While the no-code, data-configurability of the LLM agent characteristics and behavior and interconnections between agents are at the core of the preferred embodiments, the underlying implementation mechanisms remain static. These code-based implementation mechanisms for realizing the RunContexts in the agent graph interpretation mechanism may be based on existing LLM agent implementations such as OpenAI® Assistants and LangChain® Agents, but are not so limited. Accordingly, implementing code stack may include, but is not limited to: Python, LangChain, LangChain-Anthropic, LangChain-OpenAI, OpenAI, JSON interpreter (or other data exchange format including but not limited to YaML, XML, Hocon), transient library dependencies and other specific code packages representing the invention abstraction described above. For example, coded adapters may be called as needed. OpenAI assistants are an example of a coded adapter, wherein execution of agent networks are more black-box, but flexible enough to be configurable within the implementation of the agent framework described herein. Similarly, more shallow coded adapters are also envisioned. A first example of a shallow adapter is a CodedTool that facilitates our system calling out to an agent fundamentally constructed in some other agent framework. Similarly, a different kind of adapter code may be created in some other agent framework that calls an agent network constructed in our framework. An example of an existing shallow adapter is a SalesForce AgentForce agent (constrained by design).

Service implementation of chat bots and/or web-hosted functions is contained within an AGENT_MANIFEST_FILE, which has an entry for each agent network hocon specification that the server will allow access to. That is, we never really restrict a server to only serving a single agent. Users can *choose* to only serve one agent and/or have the ability to restrict what is served via this manifest file, but functionality for >1 agent network is always there now and it turns out to be less cumbersome to use overall. For purposes of service-hosted chat or functions, our already-working chatbot implementation provides asynchronous means for calling externally hosted LLMs so that multiple chat messages/requests from different users can be serviced by the same service instance simultaneously.

As described above, the data-driven agent networks are able to capture the characteristics and interconnections of multiple LLM Agents purely as a data-only construct, describable in data exchange formats such as JSON, YAML, XML, etc. so that the descriptions can be easily edited, duplicated, and deployed into various systems. These data-driven agent networks describe the computational means by which the data-only constructs are interpreted. Given the data-driven infrastructure, this no-code approach avails itself to a new class of users as agent builders, who either edit the equivalent of JSON file text directly or manipulate a UI. Users do not need to be able to code to implement, they simply describe the instructions for their agents in plain, natural language, which (depending on the LLMs used) could be English or any other written language. In all implementations, infrastructure can be provided such that the enabling code can remain a constant/standard while enabling very different behavior and/or a lower-risk performance upgrade path in that the configuration is merely data, thus enhancing the reliability of such systems.

Furthermore, with the configurability of the basis LLMs as part of the data description, interactions with the underlying LLMs can be directed to privately-hosted versions of these models (as compared to publicly hosted, e.g., ChatGPT), potentially even for different aspects of the agent network conversation, thus ensuring a tunable level of data security for precisely the times it is desired that certain interactions should be kept private.

The embodiments herein unlock a new level of customization and extensibility. With agents as ‘just data’, improvements in agents' basis instructions, natural-language logic and complexity do not require code changes. Merely pointing an agent to a new data file makes the adoption of such changes move much more quickly towards deployment or makes the same infrastructure behave in wildly new ways. New agents can be added or existing ones modified with minimal disruption, allowing for continuous improvement and adaptation to new requirements.

Further, while some assistant-based infrastructure locks you in to a particular model provider, the embodiments leverage the panoply of LLM models available, whether privately or publicly hosted, with their entire spectrum of strengths. Furthermore, the common basis for specifying which models are to be used for what tasks in a data-only fashion allows for agents developers to quickly determine which models are most appropriate model provider and/or tools to use for a particular task. Agents can interact with diverse systems and services, providing a unified interface and facilitating integration across different platforms and technologies.

Component agents in an agent network are intended to be both generalists and specialists depending on their position in the network. The data-driven embodiments herein enable agent instruction and function updates without underlying code updates. By removing the need for coding, software engineers need not be the driver for the agents' instructions. The responsibility of specialist agents development can be in the hands of true knowledge specialists: doctors, lawyers, CPAs, process specialists, specialized customer-facing personnel. Further, agents can be specialized for a particular task, leading to more efficient and optimized execution of specific functions within the application stack.

A data-driven agent network described herein affords a much higher level of re-use of existing agent definitions, whether the re-used agent definitions are in shared data within a single agent network spec, or referenced as an external tools/functions hosted by a web API given the deployment infrastructure. Especially in the web-hosting example, oft-used agent functions can be scaled up separately from other components in a larger client agent network. Multiple providers of standardized agents (again, enabled by data-driven specification) might compete for clients seeking similar functionality. Further, agents can be independently developed, deployed, and scaled without affecting the entire system.

The data-driven LLM agent network affords a standardized specification of a list of LLM models that can be used for a single agent's task. If one of these service-based LLMs is down or is too busy, policy logic allows it to move on to another, next-best option. The failure of one agent does not necessarily disrupt the entire system. Agents can be designed to handle failures gracefully, improving overall system reliability.

The data-driven nature of the embodiments allows for the additions of potentially standardized safeguarding agent sub-networks (aka monitors) which can act as detectors of malign actors by discriminating inputs to the agent. Such a specification could be made by independent experts in the field of Responsible AI to add safeguard agents to monitor and check the behavior of each agent to ensure compliance with responsible AI practices and ethical standards. Such sub-networks can be included within the data-driven agent network itself, or specified as an external sub-network as a web-host service.

As referenced above, security measures can be embedded within individual agents, providing a more granular approach to security management. Specific aspects of networked LLM agent communications can be routed to privately-hosted LLMs or agent sub-networks within a specific security perimeter so as to limit data leakage about sensitive topics. Note that the embodiments enable this even for only portions of inter-agent communications that are part of a larger agent network specification. One example of implementing this security (privacy) feature is shown in FIG. 2B, wherein requests to agent 17 are intended for a private LLM 27 as would be specified in underlying agent specifications. By way of specific example, consider the case where a user is chatting with a data-driven agent network and a user query requires private data to be shared with the root agent. If this private data (sly_data) is used by an LLM agent in the network that runs on a public LLM, then the chat streams all need to go through potentially public interfaces (e.g., OpenAI or Anthropic) to be processed; thus risking the privacy of the user's data. But if the network has an LLM agent that runs on a private LLM that can process the users private data (sly_data), then public chats may be avoided. The identification of certain user data as private, i.e., sly_data, can be shared amongst agents in a network using a shared data dictionary (e.g., private key/value data pairs) provided to the root agent alongside the user query. The dictionary is passed to agents as they are invoked without letting the private values into the chat stream which can cross security perimeters. The instructions to use a privately hosted LLM to process the private data (sly_data) are provided within the LLM specs (see 11m_config in Table 1).

Agents can optimize resource usage by adjusting their operations based on current system states, workloads and costs. Data-driven LLM agent networks afford a standardized specification of a list of LLM models that can potentially be used for a single agent's task. Priority in the list can reflect cost sensitivities and because that's “just data”, any hosting of the agent can be updated quickly to reflect the changing cost landscape. In an alternative embodiment, LLM agents could dynamically choose LLMs based on current conditions beyond the statically specified list of models. That is, any given server could maintain a current notion of which LLM types are up and functioning, and have some dynamism in their cost assessments, which could contribute to different dynamic decisions as to which LLM is used at any given moment.

Additionally, since each agent has the potential to log its intent on every transaction or call it makes to various services, transparency and traceability are enhanced.

The data-driven agent networks may implement an agent architecture called AAOSA (Adaptive Agent-Oriented Software Architecture) as described in, for example, B. Hodjat et., al., Adaptive Interaction Using the Adaptive Agent Oriented Software Architecture (AAOSA), arXiv:cs/9812015 (1998) which is incorporated herein by reference. AAOSA provides the ability to follow the AAOSA inter-agent coordination mechanism to ensure encapsulation of agent responsibilities, allowing for extensibility and automatic routing of inquiries, and ambiguity resolution over the network of agents, and allowing much better scalability, creating larger networks of agents. This approach also allows us to plug new agents and agent clusters into an existing network with minimal changes required in the rest of the system.

The present invention may be implemented in numerous ways including as a system, a method, or a computer program product such as a computer readable storage medium or a computer network wherein programming instructions are communicated from a remote location. Exemplary implementations are described in the provisional patent application 63/714,906 to which the present application claims benefit and which is incorporated herein by reference in its entirety.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications, and equivalents consistent with the principles and features disclosed herein. For purposes of clarity, details relating to technical material that is known in the technical fields related to the invention have been briefly described or omitted so as not to unnecessarily obscure the present invention.

We claim:

1. A system for facilitating single point of user access to multiple large language models to generate a response to a user query from a access, the system comprising:
a first network of agents, wherein at least two agents facilitate access to at least two different large language models; and
an interface for receiving a user's query and initiating a session with the first network of agents, wherein initiating the session includes creating an instance of a front man agent having access to a first large language model and further wherein the front man agent has access to at least a first branch agent, the first branch agent having access to a second large language model.

2. The system according to claim 1, wherein the front man agent and the first branch agent have access to one or more coded tool nodes.

3. The system according to claim 2, wherein the front man agent processes the user's query against the first large language model and determines that access to the first branch agent and the second large language model is necessary to answer the user's query.

4. The system according to claim 1, wherein the system includes a dictionary of user data which is designated as private by the user and further wherein, when the user's query includes at least some data which is designated as private, the system applies pre-established rules regarding use of the private data in one or more downstream actions.

5. The system according to claim 1, further comprising a registry of individual agents available to the user via the single point of user access, wherein the registry includes at least a list of each individual agent in the first network of agents.

6. The system according to claim 5, wherein the registry includes a listing of data-only dictionaries of each individual agent specification for each individual agent in the first network, the dictionaries being in the form of a key/value mapping.

7. The system according to claim 6, wherein the data-only dictionaries of each agent specification may be read from one or more files selected from the following text-based formats: JSON (JavaScript Object Notation), Hocon (Human-Optimized Configuration Object Notation), YAML (yet another markup language), or XML (Extensible Markup Language).

8. The system according to claim 1, wherein communications between the front man agent and at least a first branch agent is via chat streaming and further wherein chat details are stored in a journal at both the front man agent and the first branch agent.

9. The system according to claim 6, wherein the registry of agents further includes one or more dictionaries of the agent specification for one or more external agents accessible to the user via the single point of user access, wherein the one or more external agents are located in a different network of agents from the first network of agents.

10. A process for generating a response to a user query from a single point of user access to a data-driven network of agents, the process comprising:
receiving, at the single point of user access to the data-driven network, the user query;
initiating an agent session between the user and the data-driven network based on user input in the user query;
creating an instance of a front man agent having access to a first large language model;
processing, by the first large language model, the user input and determining that additional processing is required to answer the user query;
accessing, by the front man agent, instantiation instructions in an agent tool registry at the front man agent, for a first branch agent having access to a second large language model;
creating an instance of the first branch agent having access to the second large language model;
performing, by the second large language model, the additional processing in accordance with first chat input from the front man agent;
returning, by the first branch agent, a first output chat response to the front man agent based on the additional processing; and
determining, by the front man agent, that a response to the user query is complete and communicating the completed response to the user via the single point of user access to the data-driven network of agents.

11. The process according to claim 10, further comprising wherein the front man agent further determines that second additional processing is required to answer the user query;
accessing, by the front man agent, invocation instructions in the agent tool registry at the front man agent, for a first coded tool node for performing the second additional processing;
invoking the first coded tool node;
performing, by the first coded tool node, the second additional processing in accordance with second chat input from the front man agent;
returning, by the first coded tool node, a second output chat response to the front man agent based on the second additional processing; and
determining, by the front man agent, that a response to the user query is complete and communicating the completed response to the user via the single point of user access to the data-driven network of agents.

12. The process according to claim 10, further comprising:
determining, by the system, that at least part of the user data in the user query is designated as private data; and
applying one or more pre-established rules regarding use of the private data by the first or second large language models.

13. The process according to claim 10, wherein the agent tool registry is provided in the instantiation of the first branch agent having access to the second large language model.

14. The process according to claim 13, wherein the agent tool registry includes a listing of data-only dictionaries of each agent specification for each agent in the data-driven network, the dictionaries being in the form of a key/value mapping.

15. The process according to claim 14, wherein the data-only dictionaries of each agent specification is read from one or more files selected from the following text-based formats: JSON (JavaScript Object Notation), Hocon (Human-Optimized Configuration Object Notation), YAML (yet another markup language), or XML (Extensible Markup Language).

16. The process according to claim 1, wherein communications between the front man agent and the first branch agent is via chat streaming and further wherein chat details from the communications are stored in a journal at both the front man agent and the first branch agent.

17. The process according to claim 10, wherein the agent tool registry of agents further includes one or more dictionaries of the agent specification for one or more external agents accessible to one or both of the front man agent and the first branch agent, wherein the one or more external agents are located in an external data-driven network of agents.

18. A system for facilitating single point of user access to a data-driven agent network to generate a response to a user query, the system comprising:
a user interface for receiving a user's query and initiating a session with the data-driven agent network, wherein the initiated session includes,
an agent tool registry listing each individual data-driven agent in the data-driven agent network and an individual agent specification for each individual data-driven agent, and
a designation of a front man agent including a first large language model, for performing initial processing of the user query to determine a response thereto; and
multiple tools, wherein at least one of the multiple tools is a branch agent including a second large language model for performing additional processing of the user query to determine a response thereto, and further wherein the front man agent is in either direct or indirect in communication with each of the multiple tools via a data-driven chat streaming session.

19. The system of claim 18, wherein each individual data-driven agent specification is a data-only dictionary being in the form of a key/value mapping.

20. The system according to claim 19, wherein the data-only dictionaries of each data-driven agent specification is read from one or more files selected from the following text-based formats: JSON (JavaScript Object Notation), Hocon (Human-Optimized Configuration Object Notation), YAML (yet another markup language), or XML (Extensible Markup Language).

21. A system for facilitating single point of user access to a data-driven agent network to generate a response to a user query, the system comprising:
a user interface for receiving a user's query and initiating a session with the data-driven agent network;
an agent tool registry listing each individual data-driven agent in the data-driven agent network and an individual agent specification for each individual data-driven agent, wherein each individual agent specification includes a dictionary of multiple large language models accessible by each individual data-driven agent for generating a response to the user query; and
a single user-facing agent from the listing designated as the single point of user access to the data-driven agent network, including access to one or more of the multiple large language models.

22. The system of claim 21, wherein the dictionary of large language models includes identification of different large language models for different purposes.

23. The system of claim 21, wherein the dictionary of large language models includes prioritization of access to different large language models in accordance with cost.

24. The system of claim 21, wherein the dictionary of large language models includes instructions for accessing different large language models in a particular order.

25. The system of claim 21, wherein the dictionary of large language models includes identification of one or more private large language models.
